(19) United States
(12) Patent Application Publication
(10) Pub. No.: US 2026/0093140 A1
(43) Pub. Date: Apr. 2, 2026

(54) ELECTRONIC DEVICE

(71) Applicant: KYOCERA Corporation, Kyoto (JP)

(72) Inventors: Naoki NISHIZAKA, Sagamihara-shi (JP); Shingo INOUE, Yokohama-shi (JP); Keiichiro TAKAHASHI, Yokohama-shi (JP); Yosuke NAKANISHI, Yokohama-shi (JP)

(73) Assignee: KYOCERA Corporation, Kyoto (JP)

(21) Appl. No.: 19/337,225

(22) Filed: Sep. 23, 2025

(30) Foreign Application Priority Data
Sep. 30, 2024 (JP) 2024-171312

(51) Int. Cl. G02F 1/1333; G02F 1/1343; H01Q 1/22

(52) U.S. Cl. CPC G02F 1/13338; G02F 1/13439; H01Q 1/2266

(57) ABSTRACT

An electronic device includes a panel part, a sheet metal part, and a first antenna. The panel part has a first surface and a second surface on an opposite side from the first surface. The panel part includes at least one of a display that displays predetermined information on the first surface or a touch sensor that detects contact by the user on the first surface. The sheet metal part is configured to cover at least part of the second surface of the panel part. The first antenna is arranged between the panel part and the sheet metal part.

### CROSS REFERENCES TO RELATED APPLICATIONS

The present invention contains subject matter related to Japanese Patent Application No. 2024-171312 filed in the Japan Patent Office on Sep. 30, 2024, the entire contents of which are incorporated herein by reference.

### BACKGROUND OF THE INVENTION

### 1. Field of the Invention

The present disclosure relates to an electronic device. More specifically, the present disclosure relates to an electronic device having at least one of a touch sensor function or a display function, and having a wireless communication function.

### 2. Description of the Related Art

Currently, electronic devices such as smartphones and tablet terminals are widely used in the daily lives of general users. Among such electronic devices, devices that realize a contactless communication function such as near field communication (NFC) or Felica (registered trademark) are also rapidly becoming popular. In order to realize a contactless communication function, the electronic device needs to include an antenna, such as a coil-shaped antenna. However, in a relatively small electronic device such as a smartphone or tablet terminal, the internal space is very limited. For this reason, the degree of freedom in the configuration and/or arrangement of antennas used for contactless communication, etc. tends to be considerably limited.

For example, Japanese Unexamined Patent Application Publication No. 2017-228173 proposes arranging an antenna used for contactless communication, etc., on the back surface of a touchpad (the surface on the opposite side from a touch surface). On the other hand, if a coil-shaped antenna is arranged on the display surface side of a liquid crystal panel, the display of the liquid crystal panel may become difficult to see. Therefore, in such a case, a transparent electrode or the like may need to be used as an antenna so that the antenna is not visible to the user. Thus, the degree of freedom in the configuration and/or arrangement of an antenna used for contactless communication, etc., may be limited in a relatively small electronic device.

### SUMMARY OF THE INVENTION

In an embodiment, an electronic device includes a panel part, a sheet metal part, and a first antenna. The panel part has a first surface and a second surface. The second surface is on an opposite side from the first surface. The panel part includes at least one of a display that displays predetermined information on the first surface or a touch sensor that detects contact by a user on the first surface. The sheet metal part covers at least part of the second surface of the panel part. The first antenna is arranged between the panel part and the sheet metal part.

### BRIEF DESCRIPTION OF THE DRAWINGS

FIG. 1 is a front view of an electronic device according to an embodiment;

FIG. 2 is a diagram illustrating a partial cross section of an electronic device according to an embodiment;

FIG. 3 is a diagram illustrating a partial cross section of an electronic device according to an embodiment;

FIG. 4 is a front view illustrating part of a functional unit of an electronic device according to an embodiment;

FIG. 5 is a diagram illustrating a partial cross section of an electronic device according to an embodiment;

FIG. 6 is a diagram illustrating part of a display of an electronic device according to an embodiment in more detail;

FIG. 7 is a diagram illustrating simulation results of operation of an electronic device according to an embodiment;

FIG. 8A is a diagram for explaining a contactless communication function of a general electronic device; and

FIG. 8B is a diagram for explaining a problem with a contactless communication function of a general electronic device.

### DESCRIPTION OF THE PREFERRED EMBODIMENTS

In relatively small electronic devices such as smartphones or tablet terminals, increasing the degree of freedom in the configuration and/or arrangement of an antenna used for contactless communication etc. is desirable. The present disclosure relates to providing an electronic device that can have increased degree of freedom in the configuration and/or arrangement of an antenna used for contactless communication, etc. According to an embodiment, an electronic device that can have increased degree of freedom in the configuration and/or arrangement of an antenna used for contactless communication, etc. can be provided.

In the present disclosure, an “electronic device” may be a device that is driven by electric power. In particular, in embodiments described below, an “electronic device” may be an apparatus, a device, or equipment that has at least one of a touch sensor function or a display function, and has a wireless communication function. An electronic device according to an embodiment may be a general-purpose terminal or device, or a terminal or device that is specifically designed and manufactured for a purpose. For example, an electronic device according to an embodiment may be a smartphone or a tablet terminal, etc. An electronic device according to an embodiment may be any of various terminals or devices such as terminals, cash registers, or ticket gates used in various stores etc. In addition, a “system” may be a device or equipment including a device driven by electric power. A “user” may be a person (typically a human) who uses an electronic device and/or system according to an embodiment.

An electronic device according to an embodiment described below has at least one of a touch sensor function or a display function, for example, as in the case of a general smartphone or tablet terminal etc. An electronic device according to an embodiment may have both a touch sensor function and a display function, for example, as in the case of a general smartphone or tablet terminal, etc. An electronic device according to an embodiment may further include an antenna such as a coil-shaped antenna, in order to realize a contactless communication function such as near field communication (NFC) or Felica (registered trademark).

First, before describing an electronic device according to an embodiment, a problem expected to occur when realizing a contactless communication function in an electronic device such as a general smartphone or tablet terminal will be described.

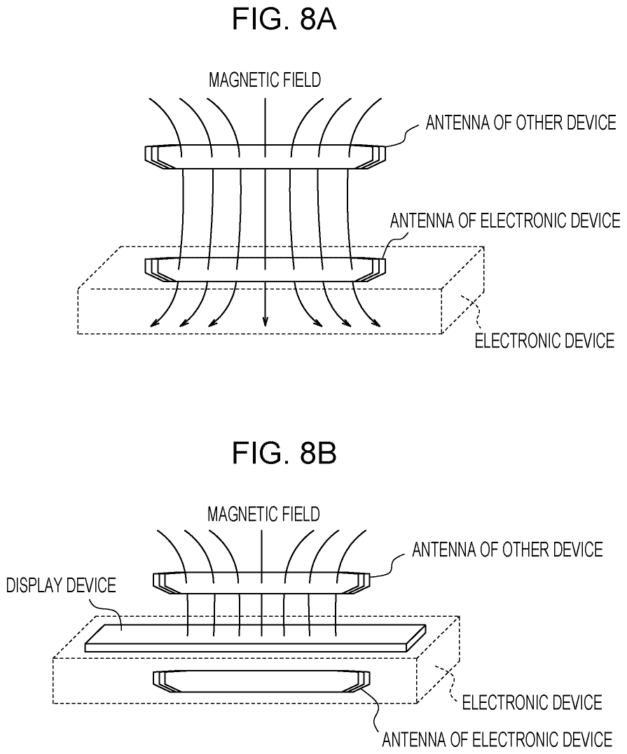

FIG. 8A is a diagram for explaining a contactless communication function of a general electronic device. FIG. 8B is a diagram for explaining a problem with a contactless communication function of a general electronic device.

FIG. 8A is a diagram conceptually illustrating how an antenna of an electronic device performs contactless communication, such as NFC or Felica (registered trademark), with an antenna of another device. The antenna of the other device is located at a relatively short distance above the electronic device illustrated in FIG. 8A. In FIG. 8A, both the antenna of the electronic device and the antenna of the other device are depicted as coil-shaped antennas. Here, the other device may be a card that is capable of near field wireless communication, such as a credit card.

The electronic device illustrated in FIG. 8A includes an antenna of the electronic device at the front surface side of housing thereof (the upper surface of the electronic device illustrated in FIG. 8A). In a situation as illustrated in FIG. 8A, the antenna of the electronic device can detect a magnetic field generated from the antenna of the other device. That is, the magnetic field generated from the antenna of the other device passes through the antenna of the electronic device. Therefore, in such a case, the electronic device and the other device can perform contactless communication with each other.

On the other hand, the electronic device illustrated in FIG. 8B includes a display device such as an LCD (liquid crystal display) at a front surface (the upper surface of the electronic device illustrated in FIG. 8B) side of the housing thereof. In many cases, the display device of an electronic device includes a support part composed of metal, for example, that supports the display device from the back surface side to ensure the strength of the display device. Furthermore, the electronic device illustrated in FIG. 8B includes an antenna of the electronic device at the back surface (the lower surface of the display device illustrated in FIG. 8B) side of the display device.

In such a case, the magnetic field generated by the antenna of the other device is blocked by the display device (the metal support part of the display device) of the electronic device as illustrated in FIG. 8B. Therefore, in the situation as illustrated in FIG. 8B, the magnetic field generated by the antenna of the other device cannot pass through or has difficultly passing through the antenna of the electronic device. Therefore, in such a case, the electronic device and the other device are expected not to be able to properly perform contactless communication with each other.

Therefore, heretofore, in order to properly perform contactless communication with the antenna of another device, measures such as arranging the antenna of the electronic device at a position that does not overlap the back surface of the display device in the electronic device were assumed to be necessary. In addition, heretofore, in order to properly perform contactless communication with the antenna of another device, measures such as arranging the antenna of the electronic device on the surface on the opposite side from the surface where the display device is arranged in the electronic device were assumed to be necessary. In this case, when properly performing contactless communication with the antenna of the other device, the surface of the electronic device on the opposite side from the surface where the display device is arranged needs to be made to face toward the antenna of the other device.

In FIGS. 8A and 8B, a case is illustrated in which the antenna of the other device functions as a transmission antenna and the antenna of the electronic device functions as a reception antenna. However, the antenna of the electronic device may function as a transmission antenna and the antenna of the other device may function as a reception antenna.

Above-mentioned Japanese Unexamined Patent Application Publication No. 2017-228173 proposes arranging an antenna used for contactless communication, etc., at the back surface (the surface on the opposite side from the touch surface) side of the touch pad. In addition, in the technology disclosed in Japanese Unexamined Patent Application Publication No. 2017-228173, the antenna may need to be made invisible to the user by using a transparent electrode or the like as the antenna. That is, in Japanese Unexamined Patent Application Publication No. 2017-228173, a special material such as a transparent electrode may need to be used for the antenna, since the antenna needs to be an element that is invisible to the user.

An electronic device according to an embodiment described below may be configured using a flexible printed circuit (FPC) etc., which has been used in the related art, while allowing a degree of freedom in the material of the antenna used for contactless communication, etc.

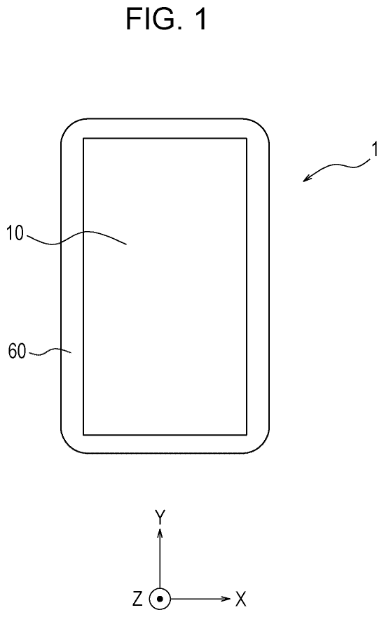

FIG. 1 is a front view of an electronic device according to an embodiment. That is, FIG. 1 is a diagram illustrating an electronic device according to an embodiment as viewed from the front.

As illustrated in FIG. 1, an electronic device 1 according to an embodiment includes a cover glass 60 and a panel part 10 as the exterior thereof as viewed from the front. The panel part 10 may include at least one of a display 20 and a touch sensor 30, as described later. The panel part 10 may also include both the display 20 and the touch sensor 30. The panel part 10 will be further described below. The cover glass 60 may be thin plate-like glass, tempered glass, or the like. The cover glass 60 may be arranged so as to cover the panel part 10. The cover glass 60 may have a function of protecting the panel part 10. The cover glass 60 may be formed to be somewhat thin, so that the touch sensor 30 can detect a touch made by a user. The cover glass 60 may be composed of a light-transmissive material, such as a transparent material, so that display shown on the display 20 can be visually observed by the user.

The Z-axis direction illustrated in FIG. 1 may mean, for example, the “thickness” direction of each member (for example, the panel part 10 and/or the cover glass 60) constituting the electronic device 1 according to an embodiment. The electronic device 1 illustrated in FIG. 1 exemplifies an embodiment, and the electronic device 1 is not limited to the size and/or shape of the electronic device 1 illustrated in FIG. 1, and may be implemented in various forms.

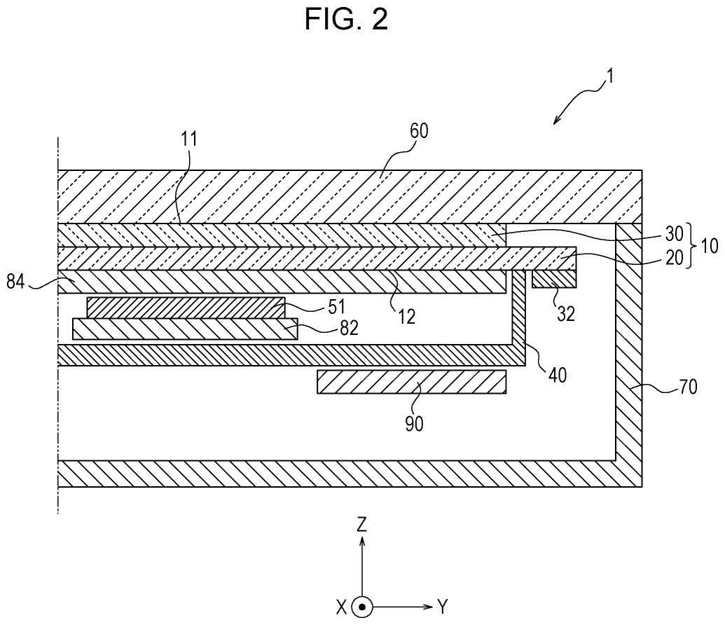

FIG. 2 is a diagram illustrating a partial cross section of the electronic device 1 according to an embodiment. That is, FIG. 2 is a diagram illustrating a partial cross section of the electronic device 1 illustrated in FIG. 1. FIG. 2 may be a diagram partially illustrating a cross section parallel to the YZ plane of the electronic device illustrated in FIG. 1.

As illustrated in FIG. 2, the electronic device 1 according to an embodiment may include the cover glass 60 and a housing 70. As described above, the cover glass 60 may be thin plate-like glass, tempered glass, transparent plastic, or the like. Furthermore, the housing 70 may define the exterior of the electronic device 1 according to an embodiment. The housing 70 may be composed of plastic or aluminum, for example.

As illustrated in FIG. 2, the electronic device 1 according to an embodiment may include the panel part 10, a sheet metal part 40, and a first antenna 51. As described above, the panel part 10 may include at least one of the display 20 or the touch sensor 30. As illustrated in FIG. 2, the panel part 10 may include both the display 20 and the touch sensor 30. In addition, as illustrated in FIG. 2, the panel part 10 may have a first surface 11 and a second surface 12 that is on the opposite side from the first surface 11. The first surface 11 of the panel part 10 may be a surface of the panel part 10, illustrated in FIG. 2, facing in the positive Z-axis direction. The second surface 12 of the panel part 10 may be a surface of the panel part 10, illustrated in FIG. 2, facing in the negative Z-axis direction.

Hereinafter, the positive Z-axis direction illustrated in FIG. 2 may be referred to as “up”. The positive Z-axis direction side of each member illustrated in FIG. 2 may be referred to as a “front” side. Similarly, the negative Z-axis direction illustrated in FIG. 2 may be referred to as “down”. In addition, the negative Z-axis direction side of each member illustrated in FIG. 2 may be referred to as a “rear” side. For example, the first surface 11 of the panel part 10 may be the upper surface or the front surface of the panel part 10. Furthermore, the second surface 12 of the panel part 10 may be the lower surface or the rear surface of the panel part 10.

When the panel part 10 includes the display 20, the display 20 can display predetermined information on the first surface 11 of the panel part 10. That is, the display 20 may have a display surface on the first surface 11 side of the panel part 10. The display 20 may be an LCD or an OLED (organic light emitting diode), for example. Furthermore, the display 20 is not limited to an LCD or an OLED, and may be various display devices. The display 20 may include a member such as TFT (thin film transistor) glass. Since the display 20 may be a known display device, a more detailed description is omitted.

When the panel part 10 includes the touch sensor 30, the touch sensor 30 can detect a touch by a user on the first surface 11 of the panel part 10. That is, the touch sensor 30 may have a touch surface on the first surface 11 side of the panel part 10. The touch sensor 30 may be, for example, a capacitance-type touch sensor. The touch sensor 30 is not limited to a capacitance-type touch sensor, and may be various types of touch (tap) detection device. The touch sensor 30 may include a member such as a CF (color filter) glass. The touch sensor 30 may be a known touch detection device, and therefore a detailed description is omitted.

The electronic device 1 according to an embodiment may include a circuit (driving circuit) 32 that drives the touch sensor 30. The driving circuit 32 may include, for example, a driver IC (integrated circuit) of the touch sensor 30. The driving circuit 32 may be disposed, for example, near an end portion of the panel part 10, as illustrated in FIG. 2.

In the electronic device 1 illustrated in FIG. 2, the touch sensor 30 is disposed at the upper side of the panel part 10, and the display 20 is disposed at the lower side of the panel part 10. However, these positions may be reversed.

As illustrated in FIG. 2, the sheet metal part 40 may be formed so as to cover at least part of the second surface 12 of the panel part 10. The sheet metal part 40 may be formed so as to cover the entire second surface 12 of the panel part 10. The sheet metal part 40 may be composed of a material such as a metal having a strength sufficient to support the panel part 10 from the rear surface side. In addition, as illustrated in FIG. 2, the sheet metal part 40 may be formed so that there is a gap between the panel part 10 and the sheet metal part 40. The first antenna 51 may be disposed in the gap. The sheet metal part 40 may be formed by a pressing process such as a drawing process.

The first antenna 51 may be configured as an antenna such as a coil-shaped antenna. The first antenna 51 may be an antenna element used for contactless communication such as near field communication (NFC) or Felica (registered trademark). As illustrated in FIG. 2, the first antenna 51 is arranged between the panel part 10 and the sheet metal part 40.

As illustrated in FIG. 2, when the first antenna 51 is disposed on the sheet metal part 40, the first antenna 51 may be attached to the sheet metal part 40 via a magnetic sheet 82.

In addition, as illustrated in FIG. 2, in the electronic device 1 according to an embodiment, when the sheet metal part 40 is attached to the panel part 10, for example, a BL (backlight) optical sheet (BL film) 84 may be interposed. As illustrated in FIG. 2, in the electronic device 1 according to an embodiment, a printed circuit board (PCB) 90 may be, for example, arranged on the rear side of the sheet metal part 40.

The electronic device 1 according to an embodiment may not include at least some of the functional parts illustrated in FIG. 2, and may include other functional parts and/or members etc. other than the functional parts illustrated in FIG. 2.

In general, sheet metal or metal foil is often arranged on the rear side (surface on opposite side from display surface) of a display used in an electronic device such as a smartphone or tablet terminal in order to reduce noise or ensure strength etc. Therefore, in an electronic device such as a general smartphone or tablet terminal, the magnetic field generated by the antenna is blocked by the sheet metal or metal foil etc. Therefore, wireless communication using the antenna is expected to become impossible or communication quality is expected to deteriorate.

In the above-mentioned Japanese Unexamined Patent Application Publication No. 2017-228173, a situation in which the magnetic field generated by an antenna is blocked can be avoided by arranging the antenna on a front surface side of the display. However, as described above, if a coil-shaped antenna is arranged on the front surface side of the display, seeing the display shown on the display may become more difficult. For this reason, in Japanese Unexamined Patent Application Publication No. 2017-228173, for example, a transparent electrode or the like may need to be used as the antenna.

In the electronic device 1 according to an embodiment illustrated in FIG. 2 as well, the sheet metal part 40 has a function of contributing to reduce noise and/or ensure strength etc. of the display 20 and/or the touch sensor 30. On the other hand, in the electronic device 1 according to an embodiment illustrated in FIG. 2, the first antenna 51 (and the magnetic sheet 82) is arranged between the panel part 10 (and the BL optical sheet 84, etc.), which includes at least one of the display 20 or the touch sensor 30, and the sheet metal part 40.

Therefore, according to the electronic device 1 of an embodiment, the magnetic field generated by the first antenna 51 in the downward direction from the electronic device 1 is blocked, whereas the magnetic field generated by the first antenna 51 in the upward direction from the electronic device 1 is not blocked. Therefore, according to the electronic device 1 of an embodiment, the function of contactless communication can be realized on the front surface side (upper surface side) of the panel part 10 including at least one of the display 20 or the touch sensor 30. Therefore, according to the electronic device 1 of the embodiment, the user can perform contactless communication using the antenna 51 while checking the display of the display 20, for example. Furthermore, according to the electronic device 1 of the embodiment, the user can perform contactless communication using the antenna 51 while operating the touch surface of the touch sensor 30, for example. When actually designing the electronic device 1, the performance of the panel part 10, which includes at least one of the display 20 or the touch sensor 30, in terms of blocking the magnetic field may be confirmed by a demonstration experiment and/or a simulation.

Furthermore, according to the electronic device 1 of an embodiment, the first antenna 51 can be arranged on the lower side (rear side) of the panel part 10, which includes at least one of the display 20 or the touch sensor 30. Therefore, according to the electronic device 1 of an embodiment, even if the first antenna 51 is configured with a normal coil or flexible substrate (FPC), the display of the display 20 is not obstructed. Therefore, according to the electronic device 1 of an embodiment, the user can, for example, easily view the display of the display 20 while a material of a normal antenna can be used for the first antenna 51.

In this way, according to the electronic device 1 of an embodiment, the degree to which the freedom of the configuration and/or arrangement of the antenna used for contactless communication or the like is restricted can be reduced. Therefore, according to the electronic device 1 of an embodiment, an electronic device that has an increased degree of freedom in the configuration and/or arrangement of the antenna used for contactless communication or the like can be provided.

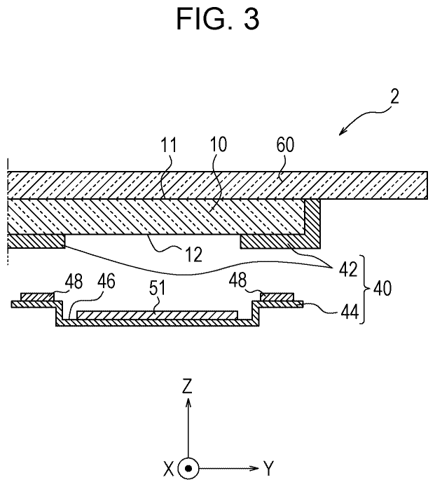

FIG. 3 is a diagram illustrating a partial cross section of an electronic device according to another embodiment. Similarly to FIG. 2, FIG. 3 may be a diagram illustrating a partial cross section of an electronic device according to another embodiment, that is, a cross section parallel to the YZ plane of the electronic device.

As illustrated in FIG. 3, an electronic device 2 according to an embodiment is obtained by changing the configuration and/or shape of the sheet metal part 40 of the electronic device 1 illustrated in FIG. 2. In addition, some of the members constituting the electronic device 2 according to an embodiment are omitted from FIG. 3. For example, FIG. 3 does not illustrate the driving circuit 32, the housing 70, the magnetic sheet 82, the BL optical sheet 84, and the printed circuit board 90 that may be included in the electronic device 2 according to an embodiment. Furthermore, FIG. 3 illustrates the display 20 and/or the touch sensor 30 as integrated with the panel part 10.

In the electronic device 1 illustrated in FIG. 2, the sheet metal part 40 is assumed to have been formed in an integrated manner. On the other hand, as illustrated in FIG. 3, in the electronic device 2 according to an embodiment, the sheet metal part 40 may be able to be separated into multiple parts.

As illustrated in FIG. 3, in the electronic device 2 according to an embodiment, the sheet metal part 40 may include, for example, a frame portion 42 and a lid portion 44. For example, the frame portion 42 may be formed as a frame member to be attached to the panel part 10, and may be attached to the second surface 12 side of the panel part 10. The lid portion 44 may be formed so as to be attached to the frame portion 42 from below. A recess 46 may be formed in the lid portion 44 at a location where the first antenna 51 is to be attached. In this case, for example, the lid portion 44 may be attached to the frame portion 42 after the first antenna 51 has been attached to the recess 46 of the lid portion 44. The frame portion 42 and/or the lid portion 44 may be formed by a pressing process such as a drawing process.

The depth (in the Z-axis direction illustrated in the figure) of the recess 46 of the lid portion 44 may be greater than the thickness (in the Z-axis direction illustrated in the figure) of the first antenna 51. By forming the recess 46 in this manner, a situation in which the upper surface of the first antenna 51 contacts the lower surface of the panel part 10 or the lower end of the frame portion 42 etc. can be avoided.

When attaching the lid portion 44 to the frame portion 42, an adhesive layer 48 may be used that is arranged to surround the periphery of the lid portion 44 and/or the frame portion 42. The adhesive layer 48 may include, for example, double-sided tape or adhesive. In this case, the adhesive layer 48 may include, for example, a conductive adhesive such as conductive double-sided tape. In this way, the noise countermeasures realized by the sheet metal part 40 including the frame portion 42 and the lid portion 44 can be expected to be further strengthened.

Thus, in the electronic device 2 according to an embodiment, the sheet metal part 40 may include the frame portion 42 and the lid portion 44. In this case, the frame portion 42 may be attached to the second surface 12 side of the panel part 10. In addition, the lid portion 44 may be attached to the frame portion 42. In this case, the first antenna 51 may be attached to the lid portion 44 of the sheet metal part 40.

In the electronic device 2 according to an embodiment, the lid portion 44 of the sheet metal part 40 may have a recess 46 at the location where the first antenna 51 is arranged. In this case, the recess 46 may be formed to have a depth equal to or greater than the thickness of the first antenna 51.

Generally, when a rigid member such as the first antenna 51 is arranged on the rear surface side (surface on opposite side from display surface) of a device such as the display 20, there is a risk that the rigid member will come into contact with the rear surface of the device, and cause a malfunction in the device. For example, when the display 20 is an LCD, if the first antenna 51 comes into contact with the rear surface of the display 20, the LCD is pressed from the rear surface, and this causes a phenomenon in which unintended content appears to bleed through the intended display on the display 20. In order to avoid such a display malfunction, for example, a step may be formed by performing a drawing process on the sheet metal part 40 as illustrated in FIG. 2. On the other hand, even when a step is formed by performing a drawing process on the sheet metal part 40 as illustrated in FIG. 2, if the end of the step comes into contact with the rear surface of the display 20, a display malfunction may still occur in the display 20.

On the other hand, in the electronic device 2 illustrated in FIG. 3, the first antenna 51 is arranged so as not to come into contact with the second surface of the panel part 10. With such a configuration, the occurrence of display defects in the display 20 in the electronic device 2 according to an embodiment can be avoided.

In addition, according to the electronic device 2 of an embodiment, the sheet metal part 40 is configured to be separable into the frame portion 42 and the lid portion 44, so that the first antenna 51 can be easily replaced. For example, if the sheet metal part 40 is manufactured as a device that is integrated with the panel part 10, if a defect is found in the first antenna 51, replacing only the first antenna 51 would be difficult and there would be a risk that the first antenna 51 and other members would need to be discarded.

However, according to the electronic device 2 of an embodiment, when a defect is found in the first antenna 51, the first antenna 51 can be easily replaced by separating the lid portion 44 from the frame portion 42. In addition, the lid portion 44 on which the first antenna 51 is installed may be commercially available, for example, as a contactless communication unit. In this case, if a defect is found in the first antenna 51, the panel part 10 including the display 20 and/or the touch sensor 30 can continue to be used as is while replacing only the contactless communication unit.

In this way, according to the electronic device 2 of an embodiment, the degree to which the freedom of the configuration and/or arrangement of the antenna used for contactless communication etc. is restricted can be reduced. Therefore, according to the electronic device 2 of an embodiment, an electronic device having an increased degree of freedom in the configuration and/or arrangement of the antenna used for contactless communication, etc. can be provided.

Next, other features that can be incorporated in the electronic device 1 and/or electronic device 2 according to the above-described embodiments will be described.

### Arrangement of Touch Sensor Driving Circuit

In a relatively small electronic device such as the electronic device 1 and/or electronic device 2 according to the above-described embodiment, the internal space is very limited. Therefore, for example, when an antenna for contactless communication such as the first antenna 51 is arranged close to the panel part 10, the distance between the circuit (driving circuit) 32 that drives the touch sensor 30 and the first antenna 51 is expected to be small.

In this case, we expect that the driving circuit 32 of the touch sensor 30 cannot be sufficiently shielded by sheet metal etc. due to structural reasons etc. in the electronic device 1 and/or the electronic device 2. If the driving circuit 32 of the touch sensor 30 cannot be sufficiently shielded, the driving circuit 32 may be affected by the magnetic field and/or noise generated when communication is performed via the first antenna 51, depending on the distance between the driving circuit 32 and the first antenna 51. If the driving circuit 32 is affected by the magnetic field and/or noise, this may cause the touch sensor 30 to malfunction.

The applicant confirmed, through demonstration experiments and/or simulations, how the touch sensor reacts when an antenna used for contactless communication or the like is placed near the driver IC of the touch sensor. As a result, the applicant confirmed that when an antenna used for contactless communication etc. is placed near the driver IC of the touch sensor, the touch sensor may be determined to have detected a touch even when the user has not actually touched the touch sensor.

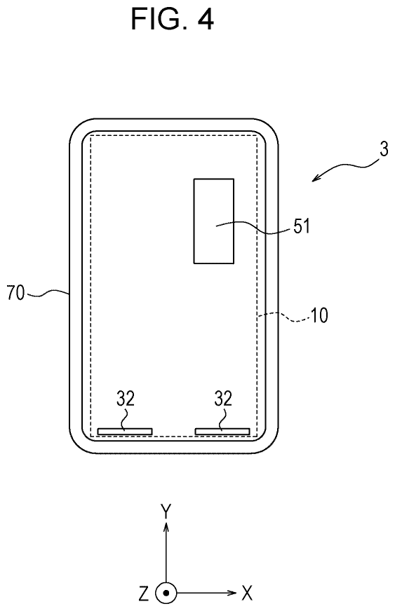

Therefore, in an embodiment, the first antenna 51 may be arranged so as to not be extremely close to the driving circuit 32 of the panel part 10. For example, as in an electronic device 3 illustrated in FIG. 4, when the panel part 10 is viewed in plan view, the first antenna 51 and the driving circuit 32 of the touch sensor 30 may be arranged so as not to overlap. In FIG. 4, the panel part 10 is indicated by a dashed line for clarity. In FIG. 4, the first antenna 51 and the driving circuit 32 of the touch sensor 30 are both arranged at the lower side (rear surface side) of the panel part 10. In addition, in an embodiment, when the panel part 10 is viewed in plan view, the first antenna 51 and the driving circuit 32 of the touch sensor 30 may be arranged so as to be spaced apart from each other to some extent. As an example, when the panel part 10 is viewed in plan view, the first antenna 51 and the driving circuit 32 of the touch sensor 30 may be arranged so as to be spaced apart by around 20 mm in the Y-axis direction illustrated in FIG. 4.

In this way, in the electronic device 1 or electronic device 2 according to an embodiment, when the panel part 10 is viewed in plan view, the first antenna 51 may be arranged at a position that does not overlap the circuit 32 that drives the touch sensor 30 of the panel part 10.

By arranging the first antenna 51 and the driving circuit 32 so as to not overlap or so as to be spaced apart from each other to some extent, the effect of the first antenna 51 on the driving circuit 32 when performing communication can be suppressed. Therefore, in this way, the risk of the touch sensor 30 erroneously detecting a touch can be reduced.

### Arrangement of Second Antenna

In recent years, electronic devices such as smartphones or tablet terminals are almost always equipped with antennas used for LTE, GPS, and/or WiFi etc., in addition to antennas used for contactless communication etc. such as the first antenna 51. However, as described above, the internal space of a relatively small electronic device such as a smartphone or tablet terminal is very limited. For this reason, the degree of freedom in the configuration and/or arrangement of not only antennas used for contactless communication, but also antennas used for, for example, LTE, GPS, and/or WiFi, tends to be very restricted. Hereinafter, an antenna used for, for example, LTE, GPS, and/or WiFi, which is different from the first antenna 51, may be referred to as a second antenna 52.

For example, if the first antenna 51 used for, for example, contactless communication and the second antenna 52 used for, for example, LTE, GPS, and/or WiFi, are arranged in close proximity to each other, the antennas may affect each other. In this case, there is a concern that the quality of communication using the first antenna 51 and the second antenna 52 may deteriorate.

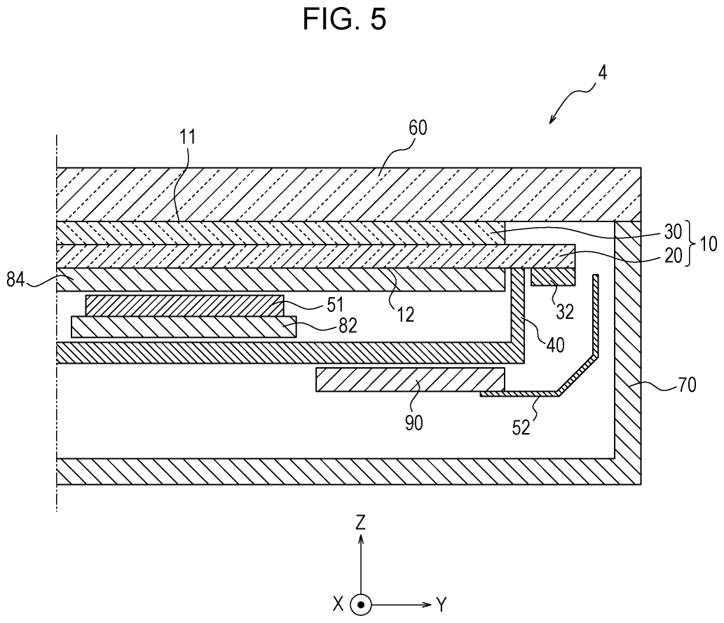

Therefore, in an embodiment, the second antenna 52 may be arranged at a position where the magnetic field generated by the first antenna 51 is blocked by the sheet metal part 40. For example, an electronic device 4 illustrated in FIG. 5 includes the second antenna 52 as an antenna used for LTE, GPS, and/or WiFi, for example. In the electronic device 4 illustrated in FIG. 5, the magnetic field generated by the first antenna 51 and heading toward the second antenna 52 is blocked by the sheet metal part 40. In addition, in the electronic device 4 illustrated in FIG. 5, the magnetic field generated by the second antenna 52 and heading toward the first antenna 51 is also blocked by the sheet metal part 40. Therefore, according to the electronic device 4, the degree of mutual influence between communication using the first antenna 51 and communication using the second antenna 52 can be reduced. In an embodiment, at least one of the first antenna 51 or the second antenna 52 may be arranged so that the sheet metal part 40 is interposed between the first antenna 51 and the second antenna 52. In the electronic device 4 illustrated in FIG. 5, the second antenna 52 is arranged outside the space formed by the panel part 10 and the sheet metal part 40.

In this way, the electronic device 1 or electronic device 2 according to an embodiment may include the second antenna 52, which is different from the first antenna 51. In this case, the second antenna 52 may be arranged outside the space formed by the panel part 10 and the sheet metal part 40.

### Display Conditions

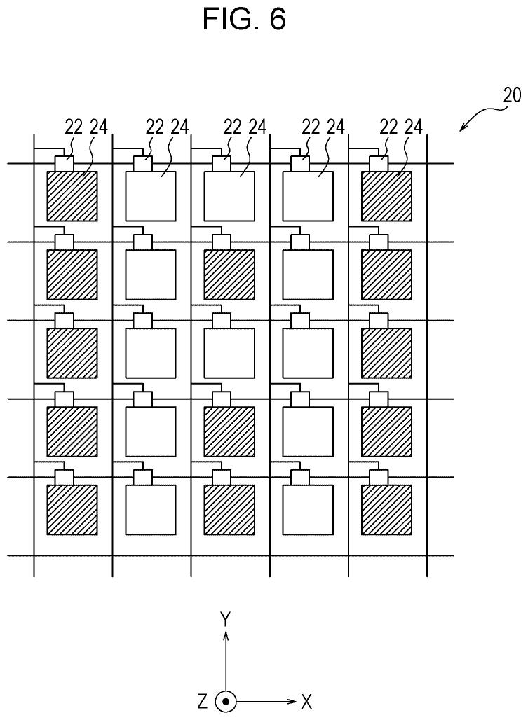

FIG. 6 is an enlarged view of part of a general display device such as the display 20 of the electronic device 1 or electronic device 2 according to an embodiment. The following description will be given taking a case where the display 20 is an LCD as an example.

As illustrated in FIG. 6, in the display 20 such as an LCD, a large number of electrodes 22 typically arranged in a grid pattern are connected to a power supply line. A liquid crystal element 24 is connected to each of the large number of electrodes 22. Each of these liquid crystal elements 24 can express a display color. In FIG. 6, only the uppermost electrodes among the large number of electrodes 22 are marked with reference symbols. Similarly, in FIG. 6, only the uppermost liquid crystal elements among the large number of liquid crystal elements 24 are marked with reference symbols.

The electrodes 22 illustrated in FIG. 6 are typically conductors (conductive material). For this reason, if the first antenna 51 is arranged at a position as illustrated in FIG. 2 or FIG. 3, there is a concern that communication using the first antenna 51 may be affected by the electrodes 22 of the display 20. Therefore, in an embodiment, the panel part 10 may suppress the current flowing through specific electrodes 22. By suppressing the current flowing through the electrodes 22, the effect of the electrodes 22 as a conductive material can be reduced.

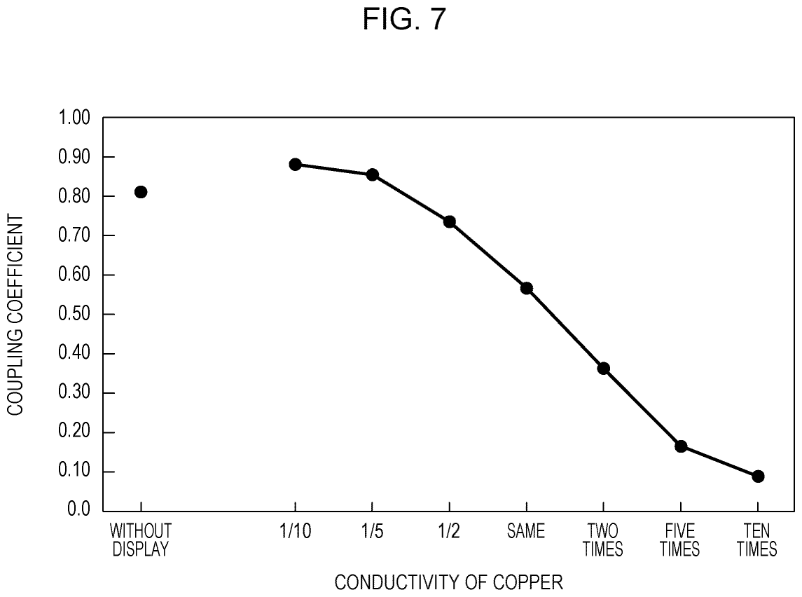

Hereafter, the conditions with which the current flowing through the electrode 22 is suppressed are further described. FIG. 7 is a diagram illustrating an example of simulation results of the effect of the electrodes 22 as a conductive material. Here, we can say that the density of the electrodes 22 in the display 20 is very small compared to a wavelength of 13.56 MHz. Therefore, in this simulation, instead of the grid pattern shape of the electrodes 22, a metal plate is used to approximate the electrodes 22. The thickness of this metal plate was assumed to be the thickness of the actual electrodes 22 and set to 0.3 μm. In addition, the communication quality realized by the transmission antenna and the reception antenna is proportional to the coupling coefficient between the antennas. Therefore, in this simulation, an evaluation was performed based on the coupling coefficient (maximum value is 1.00).

As illustrated in FIG. 7, when the conductivity of the metal plate is increased, the coupling coefficient between the transmission antenna and the reception antenna begins to fall rapidly. As a result of the simulation, we confirmed that, when the thickness of the metal plate is 0.3 μm, if the conductivity is ½ or less that of a copper plate, the effect of the electrodes can be suppressed. Therefore, when the thickness of the metal plate assumed as the electrodes 22 is 0.3 μm, the occupancy ratio of the area of the electrodes 22 to the area of the display 20 may be ½ or less. With this configuration, the effect on the communication performance of the antenna can be eliminated or reduced. In addition, the conductive performance is proportional to the thickness of the electrodes. Therefore, when the thickness of the metal plate assumed as the electrodes 22 is doubled to 0.6 μm, the occupancy ratio of the area of the electrodes 22 to the area of the display 20 may be ¼ or less. With this configuration as well, the effect on the communication performance of the antenna can also be eliminated or reduced.

In summary, the effect on the communication performance of the antenna can be eliminated or reduced by setting the product of the “thickness of the metal plate assumed as the electrodes 22” and the “occupancy ratio of the area of the electrodes 22 to the area of the display 20” to 0.15 or less.

In this way, in the electronic device 1 or electronic device 2 according to an embodiment, the thickness of the electrodes 22 that drive the liquid crystal elements 24 constituting the display 20 and the ratio of the area of the electrodes 22 to the area of the display 20 may be set to satisfy a predetermined condition.

### Sensitivity of Touch Sensor

In an electronic device such as the electronic device 1 or electronic device 2 according to an embodiment, the distance between the touch sensor 30 and the first antenna 51 is likely to be relatively small. When the distance is small, we may assume that the touch sensor 30 will be affected by the magnetic field generated by the first antenna 51, as in the case of the driving circuit 32 of the touch sensor 30. When the touch sensor 30 is affected by the magnetic field generated by the first antenna 51, there is a high risk of a malfunction occurring, such as the touch sensor 30 detecting a false touch.

In particular, in recent years, some electronic devices such as smartphones or tablet terminals have an operation mode set assuming that a user will touch the touch sensor while wearing gloves. Such an operation mode is known as, for example, a glove mode or a glove touch mode. Such an operation mode temporarily increases the sensitivity (detection sensitivity) of the touch sensor so that the touch sensor can detect a user's touch even when the user is wearing gloves. Therefore, in such an operation mode, the touch sensor 30 is affected by the magnetic field generated by the first antenna 51, and the risk of the touch sensor 30 detecting a false touch increases.

As described above, in electronic devices such as smartphones or tablet terminals, arranging the touch sensor at a distance from the antenna used for contactless communication is often difficult. On the other hand, the applicant has found through demonstration experiments and the like that noise detected by the touch sensor occurs at almost the same timing in a certain number of sensor electrodes. Therefore, in an embodiment, the noise pattern can be removed by observing the characteristics of the generated noise in advance.

By removing the noise pattern in this way, malfunctions of the touch sensor can be suppressed without affecting the signal distributions of touches made by the user's fingers or glove touches detected by the touch sensor.

In addition, for example, when the sensitivity of the touch sensor needs to be very high, we may also expect that simultaneously performing touch detection using the touch sensor and contactless communication using the antenna would be difficult. In such a case, an operation mode such as a “low-sensitivity glove mode” may be set. The “low-sensitivity glove mode” may be, for example, a mode in which the glove mode automatically becomes low sensitivity when the electronic device 1 or electronic device 2 is to perform contactless communication. In this “low-sensitivity glove mode”, for example, a touch by a user wearing relatively thin gloves can be detected, whereas a touch by a user wearing relatively thick gloves cannot be detected or is difficult to detect.

In an embodiment, the electronic device 1 or electronic device 2 may automatically start operating in an operation mode such as the “low-sensitivity glove mode” when performing contactless communication. In an embodiment, the electronic device 1 or electronic device 2 may be configured so that a user can set in advance whether or not the electronic device 1 or electronic device 2 is to automatically start operating in an operation mode such as the “low-sensitivity glove mode” when performing contactless communication.

Furthermore, in an embodiment, the electronic device 1 or electronic device 2 may allow a user to select whether or not the electronic device 1 or electronic device 2 is to start operating in an operation mode such as the “low-sensitivity glove mode” when performing contactless communication.

In this way, in the electronic device 1 or electronic device 2 according to an embodiment, the touch sensor 30 may control the sensitivity with which a touch by a user is detected depending on the effect of the magnetic field generated by the first antenna 51.

Embodiments of the present disclosure have been described based on the drawings and examples, but note that a variety of variations and amendments may be easily made by one skilled in the art based on the present disclosure. Therefore, note that such variations and amendments are included within the scope of the present disclosure. For example, the functions and so forth included in each component or step can be rearranged in a logically consistent manner, and a plurality of components or steps can be combined into a single component or step or a single component or step can be divided into a plurality of components or steps.

The above-described embodiments are not limited to being implemented only as the electronic device 1, the electronic device 2, etc. For example, the above-described embodiments may be implemented as a system including the electronic device 1 or the electronic device 2.

What is claimed is:

1. An electronic device comprising:
a panel part having a first surface and a second surface on an opposite side from the first surface, the panel part including at least one of a display that displays predetermined information on the first surface or a touch sensor that detects contact by a user on the first surface;
a sheet metal part covering at least part of the second surface of the panel part; and
a first antenna arranged between the panel part and the sheet metal part.

2. The electronic device according to claim 1,
wherein the sheet metal part includes a frame portion attached to the second surface side of the panel part and a lid portion attached to the frame portion, and
the first antenna is attached to the lid portion.

3. The electronic device according to claim 2,
wherein the lid portion includes a recess at a location where the first antenna is arranged, and
the recess is formed with a depth greater than or equal to a thickness of the first antenna.

4. The electronic device according to claim 1,
wherein the first antenna is arranged at a position that does not overlap a circuit that drives the touch sensor of the panel part when the panel is viewed in plan view.

5. The electronic device according to claim 1, further comprising:
a second antenna different from the first antenna,
wherein the second antenna is arranged outside a space formed by the panel part and the sheet metal part.

6. The electronic device according to claim 1,
wherein a thickness of an electrode that drives a liquid crystal element included in the display and a ratio of an area of the electrode to an area of the display are set to satisfy a predetermined condition.

7. The electronic device according to claim 1,
wherein the touch sensor controls a sensitivity with which contact by the user is detected in accordance with an effect of a magnetic field generated by the first antenna.

8. The electronic device according to claim 1,
wherein the first antenna is used for near field wireless communication.

9. The electronic device according to claim 1,
wherein the panel part includes both the display and the touch sensor.
